(19) United States
(12) Patent Application Publication
(10) Pub. No.: US 2018/0204538 A1
(43) Pub. Date: Jul. 19, 2018

(54) EXTERNAL LIGHT DIMMING SYSTEM AND METHOD

(71) Applicant: Continental Automotive Systems, Inc., Auburn Hills, MI (US)

(72) Inventors: Steven Robert Reckamp, Crystal Lake, IL (US); Alexander Jevtic, Chicago, IL (US); Jamon Jacob, Addison, IL (US)

(73) Assignee: Continental Automotive Systems, Inc., Auburn Hills, MI (US)

(21) Appl. No.: 15/405,686

(22) Filed: Jan. 13, 2017

(51) Int. Cl. G09G 5/10; G06F 3/01; G09G 3/36

(52) U.S. Cl. CPC G09G 5/10; G06F 3/013; G09G 2380/10; G09G 3/36; G09G 2360/144; G06F 3/011

(57) ABSTRACT

A dimming system for a vehicle includes a sensor to sense a field of view and a liquid crystal display (“LCD”) having a plurality of liquid crystals. A processor in communication with the sensor and the LCD receives a position of an eye of the occupant and determines a position of an external light source in the field of view. The processor is also configured to calculate an intersection location of the LCD and a line between eye of the occupant and the external light source. The processor is further configured to selectively command the LCD to activate at least one of the plurality of liquid crystals at or near the calculated intersection location.

### TECHNICAL FIELD

The technical field relates generally to systems for dimming a light external to a vehicle.

### BACKGROUND

Automobiles are often equipped with devices to protect the eyes of the driver and other occupants from the light of the sun. For example, sun visors can be maneuvered into positions between the eyes of the occupants and the sun. Unfortunately, such sun visors often block a substantial viewing area of the driver, thus potentially obscuring other hazards. Further, sun visors often require constant readjustment as the vehicle is in motion and the relative position of the sun with respect to the vehicle changes. Also, sun visors are typically useless when the sun is very low in the sky, e.g., near sunrise and sunset, and are not very helpful to protect the occupants from other external light sources, e.g., headlights of oncoming vehicles.

As such, it is desirable to present a dimming system to reduce hazards caused by external light sources, e.g., the sun, without the aforementioned side effects. In addition, other desirable features and characteristics will become apparent from the subsequent summary and detailed description, and the appended claims, taken in conjunction with the accompanying drawings and this background.

### BRIEF SUMMARY

In one exemplary embodiment, a dimming system for a vehicle includes a first sensor positioned to sense a position of an occupant of the vehicle and generate corresponding data. The system also includes at least one processor in communication with the first sensor and configured to receive the data generated by the first sensor and determine a position of at least one eye of the occupant based at least partially on the data generated by the first sensor. The system further includes a second sensor configured to sense a field of view outside of the vehicle and generate corresponding data. The at least one processor is in communication with the second sensor and configured to receive the generated data and to determine a position of an external light source in the field of view. The system also includes a liquid crystal display (“LCD”) disposed at least partially in a field of view of the occupant. The LCD includes a plurality of liquid crystals configured to be selectively operated in response to a command. The at least one processor is also configured to calculate an intersection location of the LCD and a line between the at least one eye of the occupant and the external light source. The at least one processor is further configured to selectively command the LCD to activate at least one of the plurality of liquid crystals at or near the calculated intersection location.

In one exemplary embodiment, a method of providing dimming of a light source external from a vehicle includes sensing a position of an occupant of the vehicle and generating corresponding data with a first sensor. The method also includes determining a position of at least one eye of the occupant based at least partially on the generated data utilizing a processor. The method further includes sensing a field of view outside of the vehicle and generating corresponding data with a second sensor. The method also includes determining a position of an external light source in the field of view utilizing the at least one processor. A liquid crystal display (“LCD”) is positioned at least partially in a field of view of the occupant, the LCD including a plurality of liquid crystals configured to be selectively operated in response to a command. The method further includes calculating an intersection location of the LCD and a line between the at least one eye of the occupant and the external light source. The method also includes selectively commanding the LCD to activate at least one of the plurality of liquid crystals at or near the calculated intersection location.

In one exemplary embodiment, a dimming system includes at least one processor configured to receive data related to a position of at least one eye of a person. A sensor is configured to sense a field of view of the person and generate corresponding data. The system includes at least one processor in communication with the second sensor and configured to receive the data generated by the sensor and to determine a position of an external light source in the field of view based at least partially on the data. The system also includes a liquid crystal display (“LCD”) disposed at least partially in the field of view of the person and including a plurality of liquid crystals configured to be selectively operated in response to a command. The at least one processor is configured to calculate an intersection location of the LCD and a line between the at least one eye of the person and the external light source. The at least one processor is also configured to selectively command the LCD to activate at least one of the plurality of liquid crystals at or near the calculated intersection location.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is block diagram of a dimming system implemented in a vehicle with two sensors according to one exemplary embodiment;

FIG. 2 is a block diagram of a dimming system implementing in a vehicle with one sensor according to one exemplary embodiment;

FIG. 3 is perspective view of an external light source through a window of the vehicle according to one exemplary embodiment;

FIG. 4 is a front view of a liquid crystal display (“LCD”) with a plurality of liquid crystals;

FIG. 5 is a side view of the LCD disposed adjacent to a window according to one exemplary embodiment;

FIG. 6 is a side view of the LCD disposed on a panel separate from the window according to one exemplary embodiment;

FIG. 7 is a front view of the LCD with a plurality of liquid crystals activated to dim an external light source according to the embodiment of FIG. 5;

FIG. 8 is a front view of the LCD with a plurality of liquid crystals activated to dim an external light source according to the embodiment of FIG. 6; and

FIG. 9 is a close-up view of the LCD with liquid crystals activated in an alternating manner.

### DETAILED DESCRIPTION

Referring to the Figures, wherein like numerals indicate like parts throughout the several views, a dimming system 100 for a vehicle 102 is shown and described herein.

The system 100 shown and described herein may be implemented in any number of vehicles 102, including, but not limited to, automobiles, trucks, motorcycles, aircraft, boats, and spacecraft. Of course, those skilled in the art will appreciate other vehicles 102 which may be suited to benefit from the described system 100 as well as non-vehicle applications. For example, the dimming system 100 may also be integrated with buildings (not shown).

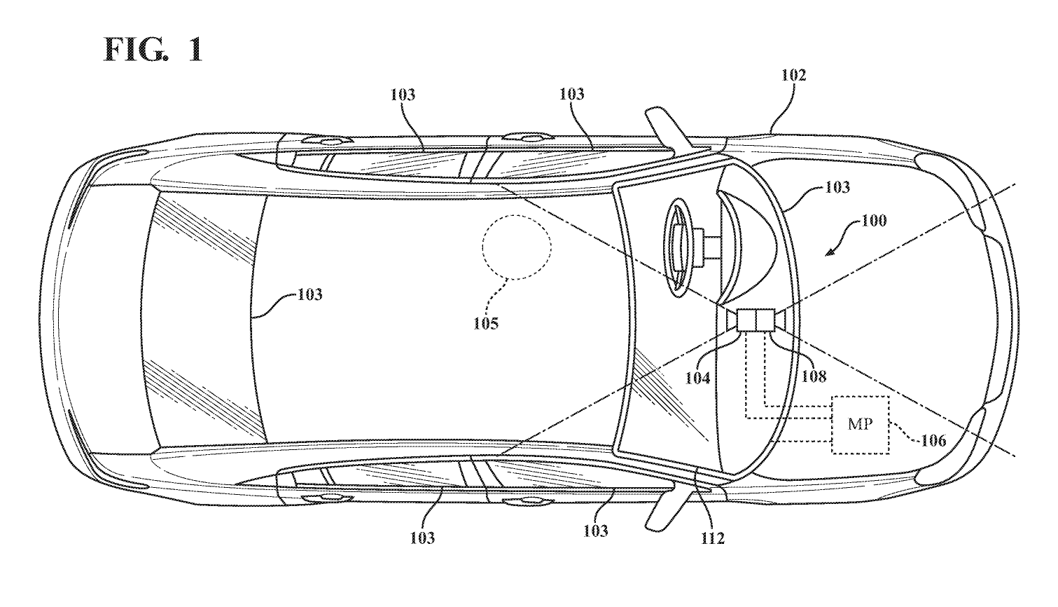

The vehicle 102 of the exemplary embodiment shown in FIG. 1 includes at least one window 103. The window 103 may be formed of one or more panes of glass (not separately numbered), e.g., tempered glass, as is readily appreciated by those skilled in the art. The window 103 may be the windshield of the vehicle 102, side windows, the rear window, a sunroof, etc., as appreciated by those skilled in the art.

In the exemplary embodiment shown in FIG. 1, the system 100 includes a first sensor 104. The first sensor 104 shown in this embodiment is a camera (not separately numbered) configured to receive an optical image and convert the optical image to digital data that may be conveyed by an electric signal. However, in other embodiments, the first sensor 104 may be implemented with other devices. In the exemplary embodiment of FIG. 1, the first sensor 104 is disposed within the vehicle 102 and is positioned to sense an occupant position, i.e., a position where an occupant 105 of the vehicle 102 may be located. More particularly, the first sensor 104 may be positioned to sense a position of an operator (e.g., a driver) of the vehicle 102 and generate data corresponding sensing activities of the first sensor 104. It should be appreciated, of course, that the first sensor 104 may comprise multiple sensors and/or sensing elements.

The system 100 also includes at least one processor 106. The at least one processor 106 may be a microprocessor, microcontroller, application specific integrated circuit (“ASIC”), or other device capable of performing calculations and/or executing instructions (i.e., running a program). It should be appreciated that the at least one processor 106 may be implemented as a single processor 106 or multiple processors 106, as appreciated by those skilled in the art. As such, the terms “at least one processor” 106, “processor” 106, or “processors” may be utilized interchangeably within this disclosure.

In the exemplary embodiment shown in FIG. 1, the processor 106 is in communication with the first sensor 104 to receive the data from the first sensor 104. The at least one processor 106 is also configured to determine a position of at least one eye of the occupant 105 of the vehicle 102 based on the data. That is, the processor 106 is configured to calculate a point in space, or relative to some known reference, of one or both of the eyes of the occupant 105 of the vehicle 102.

The at least one processor 106 may be integrated with the first sensor 104 and/or may be a separate component. Furthermore, it should be appreciated that the first sensor 104 may include one or more processors 106 while one or more additional processors 106 are separate from the first sensor 104.

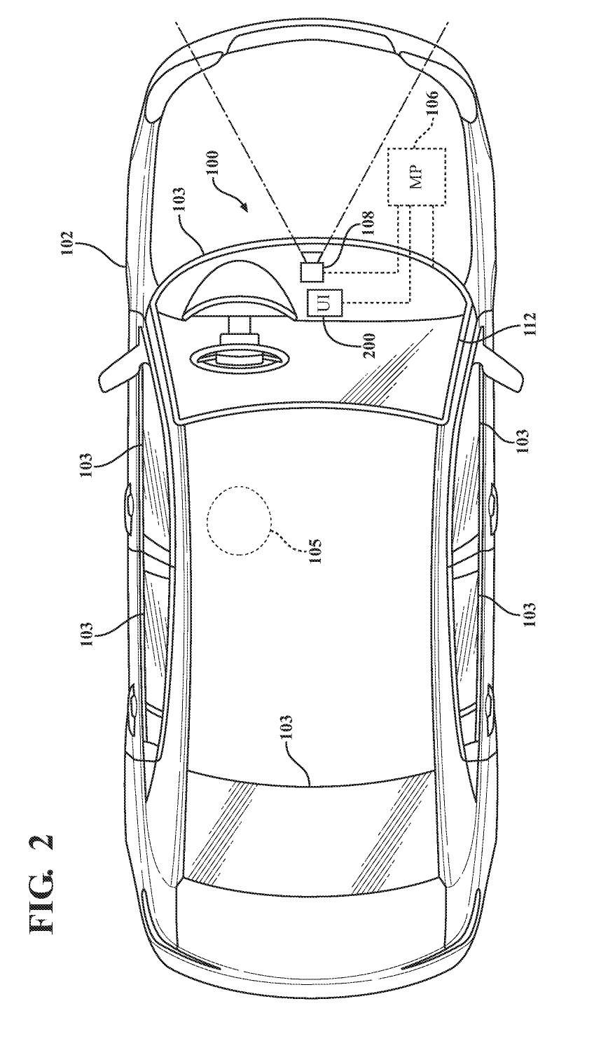

In the exemplary embodiment shown in FIG. 2, the system 100 includes a user interface 200. The user interface 200 is in communication with the at least one processor 106. As appreciated by those skilled in the art, the user interface 200, also known as a human-machine interface, allows a user to input data. As such, the user interface 200 may include buttons, dials, switches, a touchscreen display, etc., to receive the input from the user. In this exemplary embodiment, the user interface 200 is configured to receive the data related to the position of the at least one eye of the occupant and send the data to the at least one processor 106. For instance, the occupant of the vehicle could enter one or more values related to their height. As such, in this embodiment, the first sensor 104 is not required.

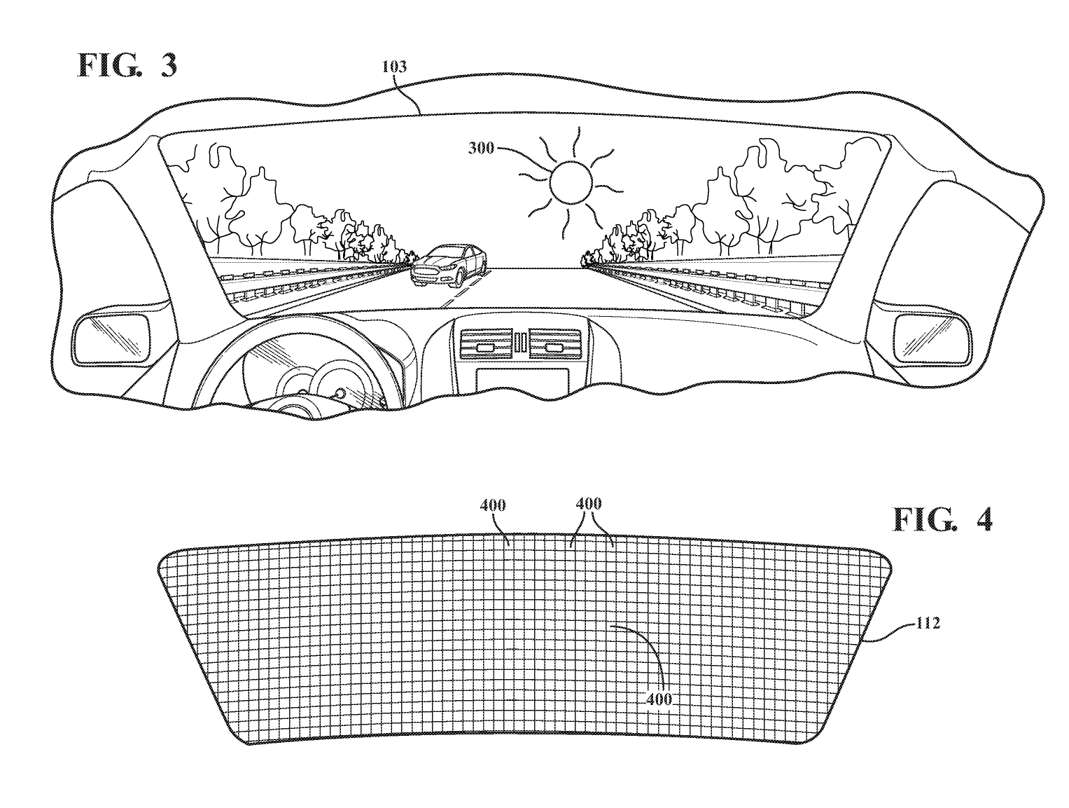

The system 100 also includes a second sensor 108. In the exemplary embodiments, where the system 100 is implemented in a vehicle 102, the second sensor 108 is configured to sense a field of view outside of the vehicle 102. Moreover, in the exemplary embodiments, the second sensor 108 is a camera (not separately numbered) configured to receive an optical image and convert the optical image to data. The data may then be carried in an electrical and/or optical signal. However, it should be appreciated that in other embodiments, the second sensor 108 may be implemented with other devices other than the camera. Furthermore, the system 100 may implement a plurality of second sensors 108 to sense multiple fields of view. As such, the plurality of second sensors 108 may provide a field of view in front of, and to the left and right of an occupant 105 of the vehicle 102. The second sensor 108 may be positioned to view external light sources 300, i.e., light sources originating outside of the vehicle 102, as shown in FIG. 3. These external light sources 300 may include, but are not limited to, the sun, reflections of the snow (i.e., off snow), and headlights of other vehicles.

The second sensor 108 is in communication with the at least one processor 106. In the exemplary embodiments, the at least one processor 106 is configured to receive the data generated by the second sensor 108 and to determine a position of one or more external light sources 300 in the field of view. More particularly, the processor 106 is configured to determine a position of the external light source 300 with respect to the second sensor 108 and/or a known point on the vehicle 102. For example, the “position” of the external light source 300 may be a pair of angles denoting the horizontal and vertical offset of the external light source 300 from the second sensor 108.

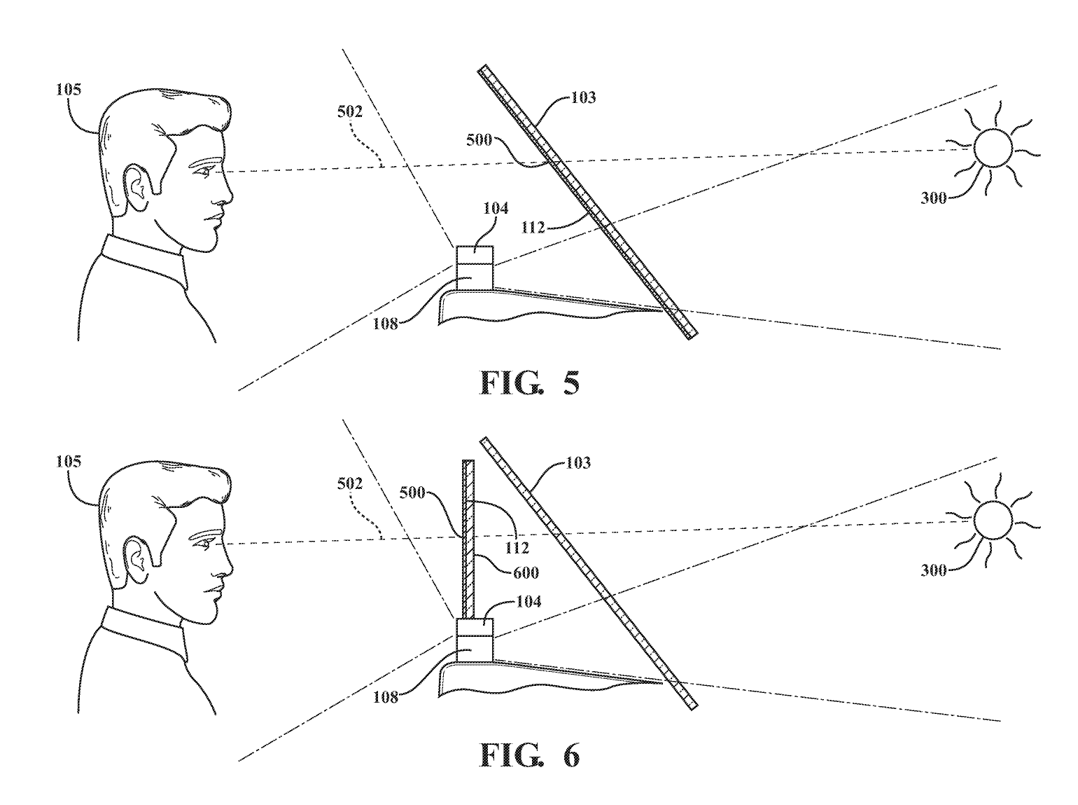

The system 100 also includes a selectively translucent material (not seperately numbered), e.g., a liquid crystal display (“LCD”) 112. The LCD 112 includes a plurality of liquid crystals 400 as shown in FIG. 4 and appreciated by those skilled in the art. The liquid crystals 400 may be referred to as pixels. The LCD 112 is disposed at least partially in the field of view of the occupant 105, as shown in FIGS. 5 and 6. That is, the LCD 112 is disposed between the occupant 105 and one of the windows 103. The LCD 112 is configured to selectively activate at least one of the plurality of liquid crystals 400 in response to a command. It should be appreciated that other materials, besides the LCD 112, may potentially be utilized as the selectively translucent material.

In the exemplary embodiment shown in FIG. 5, the LCD 112 is disposed adjacent one of the windows 103 of the vehicle 102, e.g., the windshield, as shown in FIG. 4. For example, the LCD 112 may be attached to the window 103. The LCD 112 may be disposed on a side of the glass facing the passenger compartment. In one particular embodiment, where the window 103 includes two panes of glass, the LCD 112 may be sandwiched between the two panes of glass. As such, the LCD 112 is protected from the outside elements as well as undesired contact. Furthermore, the embodiment generates a natural viewing experience for the occupant 105 of the vehicle 102. In another exemplary embodiment, as shown in FIG. 6, the LCD 112 may be disposed on a panel 600 separate from the window 103. This embodiment may provide a cost advantage, as the LCD 112 need not be replaced should the window 103 of the vehicle 102 need to be replaced, e.g., due to a crack or chip in the glass. In this embodiment, the panel 600 may be hinged (not shown) to be folded away, e.g., when the driver chooses not to utilize the LCD 112.

The at least one processor 106 is in communication with the LCD 112. The processor 106 is configured to calculate an intersection location 500 of the LCD 112 and a line 502 between the at least one eye of the occupant 105 and the external light source 300, as shown in FIGS. 5 and 6. That is, the processor 106 is configured to determine at least one liquid crystal 400 location on the LCD 112 that is between the eye(s) of the occupant 105 and the external light source 300.

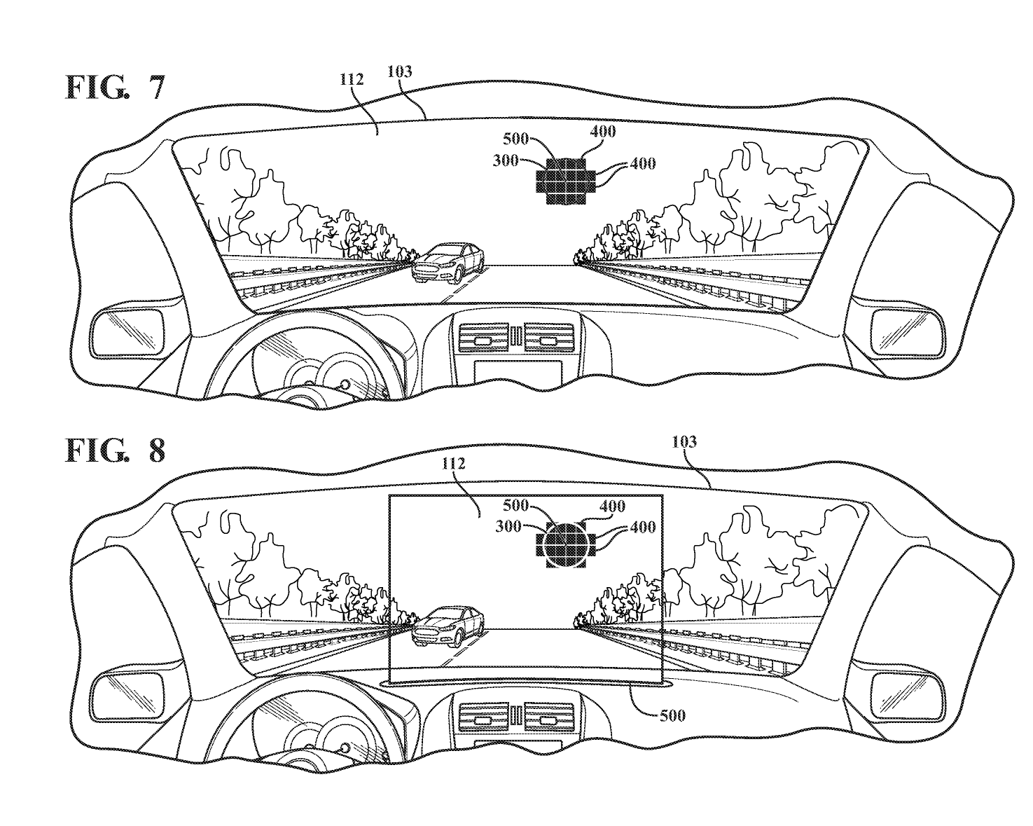

In response to the determining the intersection location 500, the processor 106 is configured to selectively command the LCD 112 to activate at least one of the plurality of liquid crystals 400 at or near the calculated intersection location 500, as shown in FIGS. 7 and 8. By activating the liquid crystals 400 at or near the calculated intersection location, the LCD 112 dims a particular section of the window 103 of the vehicle 102. Said another way, the liquid crystals 400 of the LCD 112 block or reduce all or part of the external light source 300 from the vision of the occupant 105. This allows the occupant 105 to see more clearly through the remainder of the field of view, i.e., the non-activated liquid crystals 400, without the external light source 300 providing a “blinding” effect.

The processor 106 may also calculate a relative size of the external light source 300 at the LCD 112. That is, the processor 106 determines how large or small the external light source 300 appears at the LCD 112 from the position of the occupant 105. The processor 106 is then configured to send a command to the LCD 112 to activate at least one of the plurality of liquid crystals 400 to form a shape having a size approximately equal to calculated relative size of the external light source 200. In some exemplary embodiments, the shape formed by the liquid crystals 400 may be a circle. However, other shapes, e.g., an oval, may be produced by the liquid crystals 400 to compensate for the angle of the window 103 and/or the LCD 112.

For example, at sunrise and sunset, the sun, i.e., the external light source 200, appears larger than other times of the day when it is “higher” in the sky. As such, during these times, more liquid crystals 400 may be activated to effectively dim the sun. Similarly, the headlight of an oncoming vehicle will appear to vary in size based on the distance the oncoming vehicle is away from the vehicle 102 housing the system 100 the occupant. As such, as the oncoming vehicle approaches the subject vehicle 102, additional liquid crystals 400 may be activated.

The system 100 may operate in a recursive, repetitive, or otherwise iterative manner to continuously evaluate and reevaluate which, if any, of the liquid crystals 400 of the LCD 112 should be activated. That is, the processor 106 may command different liquid crystals 400 to be activated and/or deactivated based on various changes. These changes include, but are not limited to, a changing position of the external light source 300 relative to the vehicle 102, a change in direction and/or position of the vehicle 102, a change in position of the eyes of the occupant 105 (e.g., due to movement of the head), movement of the external light source 300, and rotation of the Earth.

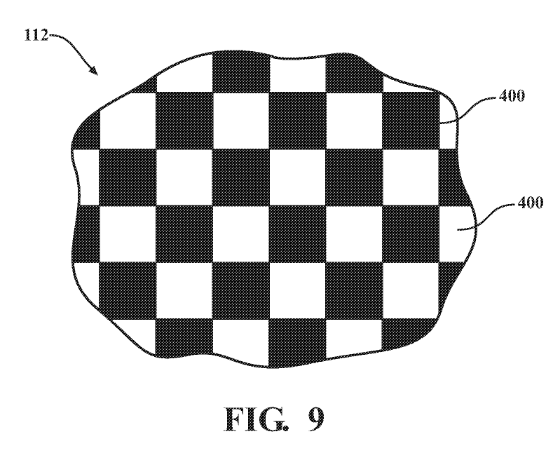

In one exemplary embodiment, the liquid crystals 400 of the LCD 112 may be selectively dimmed. For example, in one exemplary embodiment, the amount of dimming provided by the liquid crystals 400 may be controlled by controlling the electrical charge provided to each liquid crystal 400. As such, the LCD 112 may be utilized to not completely block out the external light source 300. This permits relief from the “blinding” effect of the external light source 300 while still allowing the occupant 105 to view the external light source 300. In another exemplary embodiment, the various liquid crystals 400 may be completely activate or deactivated in an alternating pattern as shown in FIG. 9. As such, the amount of dimming may be controlled without having to control the electrical charge to individual liquid crystals 400.

The at least one processor 106 may also be configured to determine whether or not to request dimming based on an intensity of the external light source 300 and an intensity of ambient light. In one example, the processor 106 may be configured to determine the intensity of the external light source 300 and the intensity of ambient light based on the data provided by the second sensor 308. The processor 106 may also be configured to determine the difference between the intensities. In one embodiment, if the difference between intensities is less than a predetermined threshold, the processor 106 will not command liquid crystals 400 to be activated. This condition could occur when, for example, headlights of an oncoming vehicle are on during the daytime, and dimming is not required and may be distracting.

The at least one processor 106 may further be configured to determine whether or not to request activation of liquid crystals 400 based on the calculated size of the external light source 300. In one example, if the calculated size of the light source 300 is equal to or greater than a predetermined percentage of the area of the window 103, the liquid crystals 400 are only partially activated, i.e., dimmed, in order to maintain visibility. In another example, if the calculated size of the light source 300 is equal to or greater than a predetermined percentage of the area of the window 103, then only a portion of the liquid crystals 400 may be dimmed. These examples may occur and be desirable when a snow environment and/or wet pavement provides a large area reflecting the external light source 300.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A dimming system for a vehicle, comprising:
a first sensor positioned to sense a position of an occupant of the vehicle and generate corresponding data;
at least one processor in communication with said first sensor and configured to receive the data generated by said first sensor and determine a position of at least one eye of the occupant based at least partially on the data generated by said first sensor;
a second sensor configured to sense a field of view outside of the vehicle and generate corresponding data;
said at least one processor in communication with said second sensor and configured to receive the generated data and to determine a position of an external light source in the field of view; and
a liquid crystal display (“LCD”) disposed at least partially in a field of view of the occupant and including a plurality of liquid crystals configured to be selectively operated in response to a command;
said at least one processor configured to calculate an intersection location of the LCD and a line between the at least one eye of the occupant and the external light source, and wherein said at least one processor is configured to selectively command said LCD to activate at least one of the plurality of liquid crystals at or near the calculated intersection location.

2. The system as set forth in claim 1, wherein said at least one processor is configured to calculate a relative size of the external light source at said LCD.

3. The system as set forth in claim 2, wherein said at least one processor is configured to send a command to said LCD to activate at least one of the plurality of liquid crystals to form a shape having an area approximately equal to calculated relative size of the external light source.

4. The system as set forth in claim 1, wherein said at least one processor is configured to determine an intensity of the external light source utilizing the data generated by said second sensor.

5. The system as set forth in claim 4, wherein said at least one processor is configured to determine an intensity of ambient light utilizing the data generated by said second sensor.

6. The system as set forth in claim 5, wherein said at least one processor is configured to calculate a difference between the intensity of the external light source and the intensity of ambient light.

7. The system as set forth in claim 1, wherein said first sensor comprises a camera.

8. The system as set forth in claim 1, wherein said second sensor comprises a camera.

9. The system as set forth in claim 1, wherein said LCD is disposed adjacent a windshield of the vehicle.

10. The system as set forth in claim 9, wherein the window includes two panes of glass and wherein said LCD is sandwiched between said two panes of glass.

11. The system as set forth in claim 1, wherein said LCD is disposed between the occupant and a window of the vehicle.

12. A method of providing dimming of a light source external from a vehicle, said method comprising:
sensing a position of an occupant of the vehicle and generating corresponding data with a first sensor;
determining a position of at least one eye of the occupant based at least partially on the generated data utilizing a processor;
sensing a field of view outside of the vehicle and generating corresponding data with a second sensor;
determining a position of an external light source in the field of view utilizing the at least one processor;
positioning a liquid crystal display (“LCD”) at least partially in a field of view of the occupant, the LCD including a plurality of liquid crystals configured to be selectively operated in response to a command;
calculating an intersection location of the LCD and a line between the at least one eye of the occupant and the external light source; and
selectively commanding the LCD to activate at least one of the plurality of liquid crystals at or near the calculated intersection location.

13. The method as set forth in claim 12, further comprising calculating a relative size of the external light source at the LCD utilizing the at least one processor.

14. The method as set forth in claim 13, further comprising sending a command from the at least one processor to the LCD to activate at least one of the plurality of liquid crystals to form a shape having an area approximately equal to calculated relative size of the external light source.

15. The method as set forth in claim 12, further comprising:
determining an intensity of the external light source utilizing the data generated by the second sensor;
determining an intensity of ambient light utilizing the data generated by the second sensor; and
calculating a difference between the intensity of the external light source and the intensity of ambient light.

16. A dimming system, comprising:
at least one processor configured to receive data related to a position of at least one eye of a person;
a sensor configured to sense a field of view of the person and generate corresponding data;
said at least one processor in communication with said second sensor and configured to receive the data generated by the sensor and to determine a position of an external light source in the field of view based at least partially on the data; and
a selectively translucent material disposed at least partially in the field of view of the person and including a plurality of dimming elements configured to be selectively operated in response to a command;
said at least one processor configured to calculate an intersection location of the selectively translucent material and a line between the at least one eye of the person and the external light source, and wherein said at least one processor is configured to selectively command said selectively translucent material to activate at least one of the plurality of dimming elements at or near the calculated intersection location.

17. The dimming system as set forth in claim 16, further comprising a user interface in communication with said at least one processor to receive the data related to the position of the at least one eye of the person and send the data to said at least one processor.

18. The dimming system as set forth in claim 16 wherein the selectively translucent material comprises a liquid crystal display (“LCD”) and the plurality of dimming elements comprises a plurality of liquid crystals.
